(19) United States
(12) Patent Application Publication
(10) Pub. No.: US 2018/0196876 A1
(43) Pub. Date: Jul. 12, 2018

(54) SENTIMENT-DRIVEN CONTENT MANAGEMENT IN A SOCIAL NETWORKING ENVIRONMENT

(71) Applicant: International Business Machines Corporation, Armonk, NY (US)

(72) Inventors: Alaa Abou Mahmoud, Dracut, MA (US); Paul R. Bastide, Boxford, MA (US); Fang Lu, Billerica, MA (US)

(21) Appl. No.: 15/401,026

(22) Filed: Jan. 7, 2017

(51) Int. Cl. G06F 17/30; G06F 19/00; G06Q 50/00

(52) U.S. Cl. CPC G06F 17/30867; G06Q 50/01; G06F 19/322; G06F 17/3089

(57) ABSTRACT

Disclosed aspects relate to sentiment-driven content management in a social networking environment. A set of user-derived data may be detected in a social networking environment. The set of user-derived data may indicate a negative sentiment of a user that corresponds with the set of user-derived data. A sentiment modification action for the social networking environment may be determined. The determination of the sentiment modification action may be based on the set of user-derived data which indicates the negative sentiment of the user. A set of selected social networking data may be provided to the user. The set of selected social networking data may be provided in the social networking environment based on the sentiment modification action.

### BACKGROUND

This disclosure relates generally to computer systems and, more particularly, relates to sentiment-driven content management in a social networking environment. Social network environments may be used to facilitate message communication and sentiment expression between users. The amount of information communicated using social networking environments is increasing. As the amount of information communicated using social networking environments increases, the need for sentiment management may also increase.

### SUMMARY

Aspects of the disclosure relate to sentiment-driven presentation of social networking data in a social networking environment. Disclosed aspects may recognize a negative sentiment trend of a specific user in the social networking environment. The negative sentiment trend of the user may be indicated by, for example, the use of negative keywords, phrases, emojis, images, etc. Disclosed aspects may determine a sentiment modification action to change the sentiment of the user. For example, the sentiment modification action may be intended to change the negative sentiment of the user to a positive one. Aspects of the disclosure may provide, promote, or create a set of selected positive sentiment social networking data to the user in their specific social networking environment.

Disclosed aspects relate to sentiment-driven content management in a social networking environment. A set of user-derived data may be detected in a social networking environment. The set of user-derived data may indicate a negative sentiment of a user that corresponds with the set of user-derived data. A sentiment modification action for the social networking environment may be determined. The determination of the sentiment modification action may be based on the set of user-derived data which indicates the negative sentiment of the user. A set of selected social networking data may be provided to the user. The set of selected social networking data may be provided in the social networking environment based on the sentiment modification action.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level block diagram of a computer system for implementing various embodiments of the present disclosure, according to embodiments.

FIG. 2 is a flowchart illustrating a method of sentiment-driven content management in a social networking environment, according to embodiments.

FIG. 3 is a flowchart illustrating a method for sentiment-driven content management in a social networking environment, according to embodiments.

FIG. 4 shows an example system for sentiment-driven content management in a social networking environment, according to embodiments.

FIG. 5 illustrates an example social networking interface for sentiment-driven content management, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to sentiment-driven presentation of social networking data in a social networking environment. Disclosed aspects may recognize a negative sentiment trend of a specific user in the social networking environment. The negative sentiment trend of the user may be indicated by, for example, the use of negative keywords, phrases, emojis, images, etc. Disclosed aspects may determine a sentiment modification action to change the sentiment of the user. For example, the sentiment modification action may be intended to change the negative sentiment of the user to a positive one. Aspects of the disclosure may provide, promote, or create a set of selected positive sentiment social networking data to the user in their specific social networking environment.

Social networking environments may be used to connect people and information in a logical and organized way. This may enable the sharing and processing of information between users. A few popular mechanisms of sharing and processing information are the inbox, wall, activity stream, timelines, or profile. The mechanisms listed, along with other mechanisms, may enable a user to rapidly share information with others, as well as gather information from others, in their social networking environment. Billions of messages may be sent between users each day. These messages may have the power to change the mindset or sentiment of the user—negative-to-positive, positive-to-negative, or other changes. Each message may provide a strong impact for a user who is suffering from a physical, mental, or even terminal illness. A higher level of social support through the social networking environment may more positively adjust the attitude of the user. A positive attitude, sentiment, or energy from the user may lead to a more positive outcome.

Aspects of the disclosure include a system, method, and computer program product for sentiment-driven content management in a social networking environment. A set of user-derived data may be detected in a social networking environment. The set of user-derived data may indicate a negative sentiment of a user that corresponds with the set of user-derived data. A sentiment modification action for the social networking environment may be determined. The determination of the sentiment modification action may be based on the set of user-derived data which indicates the negative sentiment of the user. A set of selected social networking data may be provided to the user. The set of selected social networking data may be provided in the social networking environment based on the sentiment modification action.

Aspects of the disclosure relate to providing the user with a set of selected social networking data based on the sentiment modification action. In embodiments, the sentiment modification action may include the introduction of positive social networking content to the user. In various embodiments, the sentiment modification action may include the removal of negative sentiment content from the viewstream of a user. In certain embodiments, a sentiment trend of the user may be monitored, which may cause the sentiment modification action to change in response. In various embodiments, the sentiment modification action may include the introduction of a facilitator-user with the intention of introducing more positive content to the social networking environment of the user. In certain embodiments, the user may be surveyed with respect to the set of selected social networking data introduced by the sentiment modification action. The surveying of the user may enhance the sentiment modification action with regards to the specific user. Altogether, aspects of the disclosure can have performance or efficiency benefits (e.g., reliability, speed, flexibility, responsiveness, stability, high availability, resource usage, productivity). Aspects may save resources such as bandwidth, disk, processing, or memory.

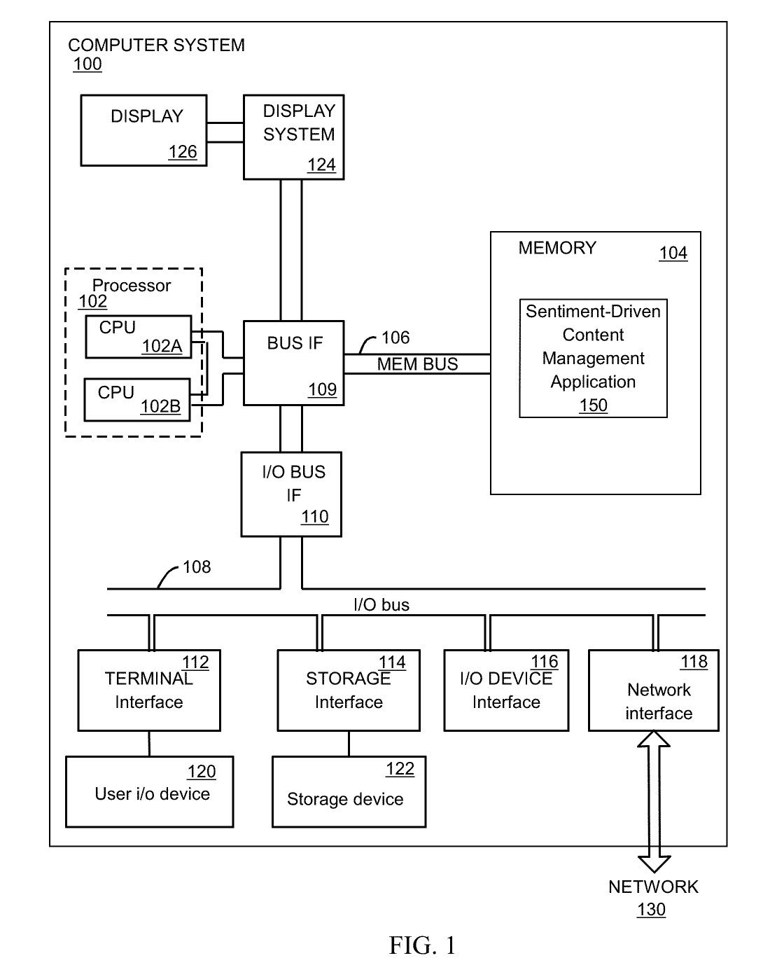

Turning now to the figures, FIG. 1 depicts a high-level block diagram of a computer system for implementing various embodiments of the present disclosure, according to embodiments. The mechanisms and apparatus of the various embodiments disclosed herein apply equally to any appropriate computing system. The major components of the computer system 100 include one or more processors 102, a memory 104, a terminal interface 112, a storage interface 114, an I/O (Input/Output) device interface 116, and a network interface 118, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a sentiment-driven content management application 150. In embodiments, the sentiment-driven content management application 150 may include instructions or statements that execute on the processor 102 or instructions or statements that are interpreted by instructions or statements that execute on the processor 102 to carry out the functions as further described below. In certain embodiments, the sentiment-driven content management application 150 is implemented in hardware via semiconductor devices, chips, logical gates, circuits, circuit cards, and/or other physical hardware devices in lieu of, or in addition to, a processor-based system. In embodiments, the sentiment-driven content management application 150 may include data in addition to instructions or statements.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 114, 116, and 118, which are also known as I/O processors (IOPs) or I/O adapters (IOAs), through the I/O bus 108. The display system 124 may include a display controller, a display memory, or both. The display controller may provide video, audio, or both types of data to a display device 126. The display memory may be a dedicated memory for buffering video data. The display system 124 may be coupled with a display device 126, such as a standalone display screen, computer monitor, television, or a tablet or handheld device display. In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 120, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 120 and the computer system 100, and may receive output data via the user output devices. For example, a user interface may be presented via the user I/O device 120, such as displayed on a display device, played via a speaker, or printed via a printer.

The storage interface 114 supports the attachment of one or more disk drives or direct access storage devices 122 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 122 may be implemented via any type of secondary storage device. The contents of the memory 104, or any portion thereof, may be stored to and retrieved from the storage device 122 as needed. The I/O device interface 116 provides an interface to any of various other I/O devices or devices of other types, such as printers or fax machines. The network interface 118 provides one or more communication paths from the computer system 100 to other digital devices and computer systems; these communication paths may include, e.g., one or more networks 130.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown, which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

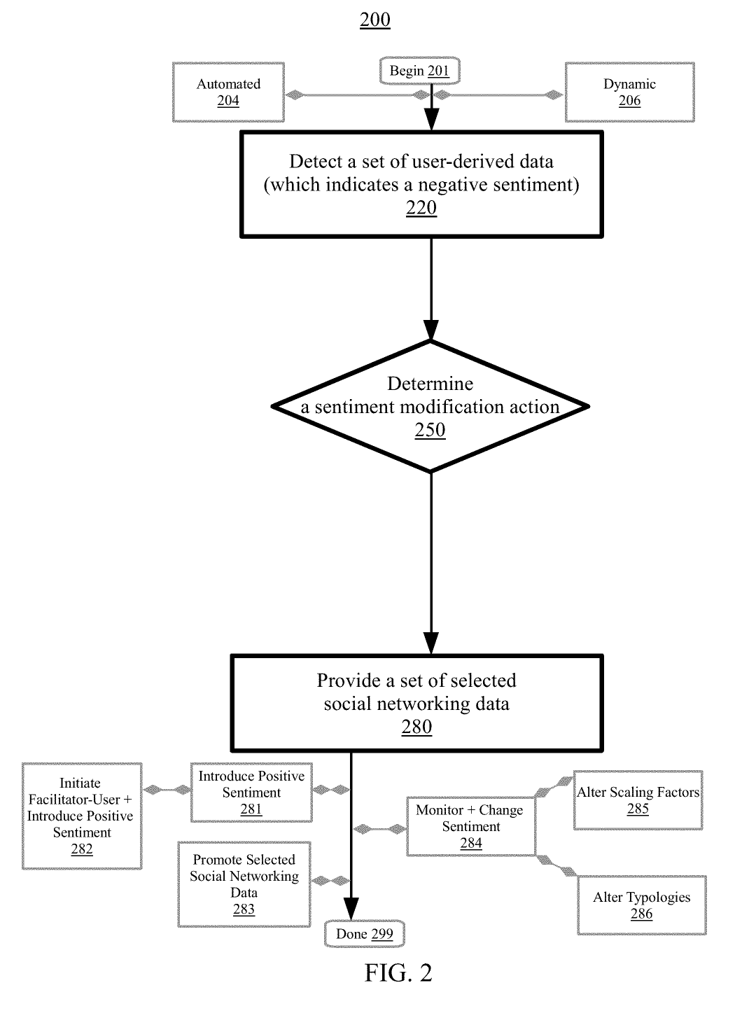

FIG. 2 is a flowchart illustrating a method 200 for sentiment-driven content management in a social networking environment. The social networking environment may include a selection from a group consisting of at least one of: email, calendar, instant messaging (IM), short message, or other form of social networking communication. The method 200 may begin at block 201. In embodiments, the detecting, the determining, the providing, and other steps described herein may each occur in an automated fashion without user intervention at block 204. In embodiments, the detecting, the determining, the providing, and other steps described herein may be carried out by an internal sentiment management module maintained in a persistent storage device of a local computing device (e.g., mobile computing device of a user). In certain embodiments, the detecting, the determining, the providing, and other steps described herein may be carried out by an external message management module hosted by a remote computing device or server (e.g., social network environment accessible via a subscription, usage-based, or other service model). In this way, aspects of sentiment-driven content management may be performed using automated computer machinery without manual action. Other methods of performing the steps described herein are also possible. In embodiments, the detecting, the determining, the providing, and other steps described herein may each occur in a dynamic fashion to streamline sentiment-driven content management at block 206. The detecting, the determining, the providing, and other steps described herein may each occur in a dynamic fashion to streamline sentiment-driven content management. For instance, the detecting, the determining, the providing, and other steps described herein may occur in real-time, ongoing, or on-the-fly. As an example, one or more steps described herein may be performed simultaneously (e.g., the set of user-derived data for the specific user or group of users may be captured in real-time while the user composes an instant message) in order to streamline (e.g., facilitate, promote, enhance) sentiment-driven content management. Altogether, leveraging sentiment-driven content assessment for a communication may be associated with content relevance, ease of understanding, and communication reliability.

At block 220, a set of user-derived data may be detected in the social networking environment. Generally, detecting can include sensing, recognizing, discovering, identifying, ascertaining, receiving, or otherwise detecting the set of user-derived data. The set of user-derived data may include information in a form such as text, still images, moving video, or other forms of information that may be found in the social networking environment. The set of user-derived data may have various parameters, parameter values, variables, syntax, semantics, content portions, meta data or other parameters. The set of user-derived data may come from, result from, be based on, or arise out of information from a particular user (e.g., individual, computer user, person). The user-derived data can include social networking data (e.g., substantive contents of an email, meta data linked with a micro-blog entry, an emoji count of a text message), behavioral data (e.g., hitting the keyboard beyond a threshold level of received pressure, registering the cell phone being placed down beyond a threshold level of force, processing the number of words typed per minute against a pre-established benchmark), computer vision data (e.g., facial expressions, eye gaze information, smiling), or other types of data. The set of user-derived data may indicate a negative sentiment of a user that corresponds with the set of user-derived data. The negative sentiment may be linked with a specific user. The negative sentiment may include attitude (e.g., sympathetic, accusatory, judgmental), position (e.g., agreement, disagreement, neutral), opinion (e.g., positive, negative, indifferent), emotions (e.g., anger, sadness, fear), or other types of actions.

Consider the following example. A user may log on to their social networking environment. After viewing a social networking post (e.g., video, photograph, message) that contains conflicting political views, the user may hit the keyboard abnormally hard while responding to this post. This behavioral data may be detected in the social networking environment. This behavior may indicate a negative sentiment of the user (e.g., anger, disagreement, accusatory attitude). Other methods of detecting the set of user-derived data in the social networking environment are also possible.

At block 250, a sentiment modification action may be determined for the social networking environment. Generally, determining can include computing, formulating, identifying, resolving, selecting, calculating, or otherwise ascertaining the sentiment modification action for the social networking environment. The sentiment modification action can include an operation, executed-step, or process that (is intended to) alters, changes, adjusts, or influences the sentiment of one or more users. The sentiment modification action may include, for example, introducing a positive sentiment to the user, removing negative sentiment from the user's social networking environment, or other actions. The sentiment modification action may be introduced to, implemented in, hosted by, or presented with respect to the social networking environment. The determination of the sentiment modification action may be based on the set of user-derived data which indicates the negative sentiment of the user. The set of user-derived data may be analyzed, compared, or evaluated with respect to one or more thresholds, benchmarks, or equilibrium points to determine the sentiment modification action. For instance, an evaluation may be performed on the set of user-derived data with respect to similar data for a like group of users other than the specific user. The evaluation can compare the set of user-derived data with various statistical measures (e.g., benchmarks, variances, deviations, clustering) to ascertain how the set of user-derived data relates to a calculated norm. As another example, the set of user-derived data may be analyzed with respect to a baseline for the particular user the data was derived from (e.g., historical data for the user).

Consider the following example. After viewing a social networking post that contains conflicting political views, the user may become angry. The computer-implemented method may detect this anger compared to a pre-established benchmark anger-level of the user and may use the user-derived data to determine a sentiment modification action to counteract the anger of the user in order to have a calming effect. The sentiment modification action may include the removal of posts containing political content, the promotion of posts containing soothing content, or other actions. Other methods of determining the sentiment modification action are also possible.

At block 280, a set of selected social networking data may be provided to the user. Generally, providing can include presenting, transmitting, sending, displaying, conveying, or delivering the set of selected social networking data. The providing of the set of selected social networking data may be based on the sentiment modification action (e.g., a selected operation to be performed). The set of selected social networking data may be provided in the social networking environment. The set of selected social networking data can include new or existing social networking data which is tailored, chosen, or otherwise selected consistent with aspects described herein. The tailoring, choosing, or selecting of social networking data may be based on, related to, or otherwise in correspondence with user-specific subjects, keywords, or other interests of the specific user or group of users. The selected social networking data may be based on historical data of the specific user, data from a similar type of user, or other methods of selecting user-specific data. The set of selected social networking data can include messages, still images, videos, and other data. The set of selected social networking data may be a portion of a set of information in the social networking environment, a segment of a set of information which has appeared in a viewstream of the user, or a real-time feed such as a video meet-up.

Consider the following example. After detecting that the user may be angry and determining that the user may need to calm down, the sentiment modification action may include providing the user with a photograph of a sunset at their favorite beach, a video of their grandchildren, or other selected social networking data. The selected social networking data may have a calming effect on the user. The negative sentiment that the user may have felt may become positive sentiment through the providing of the selected social networking data. Other methods of providing the set of selected social networking data are also possible.

In embodiments, a positive sentiment may be introduced to the user in the set of selected social networking data at block 281. The positive sentiment may be introduced, promoted, enlarged, added, increased, or otherwise presented to the user or group of users. The positive sentiment may be introduced through a message, still image, video, or other type of social networking data. The positive sentiment may include attitude (e.g., confidence, thoughtfulness, optimism), position (e.g., agreement, disagreement, neutral), opinion (e.g., positive, negative, indifferent), emotions (e.g., hope, gratitude, amusement), or other types of actions. The positive sentiment may be introduced to carry-out the sentiment modification action.

Consider the following example. A user who is suffering from a terminal illness may be using their social networking environment. The program may introduce a positive sentiment to the specific user. The introduction of the positive sentiment may include the promotion of a video of the user's favorite sports team to the top of the user's feed or viewstream. The introduction of the positive sentiment may also include the enlarging of a photo beyond the original size of the photo posted by the user's close friend of a happy memory the two of them shared. Other methods of introducing a positive sentiment to the user in the set of selected social networking data are also possible.

In embodiments, initiation of a facilitator-user and introduction of positive sentiment may occur at block 282. An interaction with a facilitator-user may be initiated through the program to the user in the set of selected social networking data. The facilitator-user may be a user of a social networking environment. The facilitator-user may include a delegate, representative, medical professional user, organizational leader, family member user, or other individual arranged to introduce positive sentiment to the specific user. The interaction may be initiated through promotion, scaling, recommendation, suggestion, or other methods of introduction initiated by the program. The interaction may include messages, blog posts, videos, or other forms of social networking interaction. The initiation may occur to carry-out the sentiment modification action. The initiation may create, generate, or otherwise construct the desired sentiment for the specific user. The positive sentiment from the facilitator-user may be introduced. The positive sentiment from the facilitator-user may be promoted, suggested, or otherwise provided to the specific user. The positive sentiment may include posts (e.g., inspirational stories, educational videos, calming still images), dialogue (e.g., open forums, personalized messages, comments), or other forms of communication and interaction. The introduction of the positive sentiment may occur in the set of selected social networking data.

Consider the following example. The specific user may be a cancer patient who may be expressing a negative sentiment. The program may introduce to the specific user a facilitator-user such as a doctor or therapist. The facilitator-user may introduce to the specific user the set of selected social networking data, such as data related to warm weather, balloons and celebration, and cheerful music. The facilitator-user may introduce to the specific user a music video of an uplifting song. The video may be introduced to the patient through the movement of the video to the top of their viewstream or through a promotion on the patient's social networking feed. The patient may view the video introduced through the interaction with the facilitator-user and may become more optimistic by listening to the song and watching the video. The patient may be introduced to a more positive sentiment. Other methods of initiating an interaction from a facilitator-user and introducing the positive sentiment from the facilitator-user may also be possible.

In embodiments, the set of selected social networking data may be promoted with respect to other social networking data at block 283. The set of selected social networking data may be introduced, placed, enlarged, or otherwise promoted in the social networking environment of the user or group of users. The promotion of the set of selected social networking data may be in a viewstream to carry-out the sentiment modification action. The viewstream may include a timeline, live activity feed, or other interface including a stream of social media content.

Consider the following example. A specific user, such as an athlete, may be angry or upset after losing a big game. The specific user may post angry updates, send messages with negative emojis, or other methods of expressing negative sentiment. A negative sentiment (e.g., anger, sadness) may be detected in the social networking environment. A sentiment modification action may be determined to introduce a positive sentiment to the user. The sentiment modification may include the promotion of videos of the user's favorite band, the promotion of a message from a close friend, or the promotion of other positive sentiment content. The promotion may occur through the placement of the video to the top of the user's feed. The promotion may also occur through freezing the message from the friend at the top of the user's viewstream, highlighting at least a portion of the message, or flashing the message to draw the user's attention. Other methods of promoting the selected social networking data with respect to other social networking data are also possible.

In embodiments, monitoring and changing may occur at block 284. A sentiment trend of the user may be monitored in response to providing the set of selected social networking data to the user. The monitoring may include tracking, tracing, observing, or otherwise examining the sentiment trend of the user once provided with the set of selected social networking data. The monitoring may occur through the detection of user-derived data such as actions, behaviors, attitudes, and other methods described herein. The sentiment trend of the user may include how the specific user or group of users reacts, responds, or otherwise acts once provided with the set of selected social networking data. This reaction may be positive (e.g., smiling, use of happy emojis, re-posting the selected social networking data), negative (e.g., slamming down the phone, reddening of the face, messages with anger keywords), or remain the same. The sentiment modification action may change based on the sentiment trend of the user. The sentiment modification action may adjust, modify, alter, or otherwise change in response to the reaction of the user or group of users. The sentiment modification action may consist of other methods, processes, or procedures to change the sentiment of the user or group of users.

Consider the following example. A specific user, such as a high school student who is a victim of bullying, may view social networking data posted by or related to the other student or students that are bullying the specific user. The program may monitor negative sentiment from the user, such as an increased nervous heart rate or messages indicating depression. The sentiment modification action may include providing the specific user with more posts related to their close friends or videos of puppies arranged to calm the user. As a result, the sentiment modification may be successful and may not require any change. As such, the user may continue to be provided with posts by their close friends or videos of puppies. In certain instances, the positive sentiment introduced may not sufficiently calm the user. The program may monitor that the user is agitated above a threshold in response to the introduction of positive sentiment. The sentiment modification action may change to include the filtering-out or removal of posts related to the other students. The filtering-out or removal of these posts may cause the specific user to calm down. Other methods of monitoring a sentiment trend of the user and changing the sentiment modification action are also possible.

In embodiments, a set of scaling factors of the sentiment may be altered at block 285. The altering of the set of scaling factors of the sentiment may occur based on the sentiment trend of the user. The program may measure, compare, calculate, or otherwise ascertain whether the sentiment modification action needs to be altered. The scaling factors may be a predetermined coefficient, a benchmark factor, or other scaling factor meant to indicate a trend value. The scaling factors of the sentiment may determine whether the sentiment modification action should be amplified or reduced. The scaling factors may indicate that the sentiment level of the user is below a predetermined coefficient or benchmark factor, or differing from a trend value of the specific user. The sentiment modification action may be altered (e.g., increasing, decreasing, no change) in correspondence with the scaling factors. The relative amount/volume of the selected social networking data provided to the user may be altered in response.

Consider the following example. The specific user, the high school bullying victim mentioned herein, may respond positively to the introduction or promotion of posts related to their close friends or videos of puppies. The specific user may not respond as positively as usual based on a predetermined level of baseline happiness. The program may compare this current level of positive sentiment with the baseline level of positive sentiment and may detect that the user is still not at a threshold happiness level. The sentiment modification action may be altered in response to these scaling factors. The positive sentiment content related to close friends and puppies may appear in the user's social networking environment more frequently, or more change in size to be made more visible. The sentiment modification action may also change the specific friends appearing in the posts or the breed of dog appearing in the videos (e.g., to a breed more favored by the user). Other methods of altering a set of scaling factors of the sentiment modification action are also possible.

In embodiments, a set of typologies of the sentiment modification action may be altered at block 286. The set of typologies may include the type of action, process, or procedure through which the sentiment modification action occurs. The set of typologies of the sentiment modification action may include a providing operation, a promoting operation, a posting operation, a removing operation, a filtering-out operation, a deleting operation, a demoting operation, a sizing operation, a scaling operation, a filtering-in operation, or other operations (e.g., as described herein). The altering may include changing, varying, modifying, revising, or otherwise adjusting the set of typologies of the sentiment modification action. The altering of the set of typologies of the sentiment modification action may occur based on the sentiment trend of the user. In response to the sentiment trend of the user, the sentiment modification action may alter, change, or adjust the set of typology of the sentiment modification action.

Consider the following example. The user may be an elderly patient in a nursing home who may use their specific social networking environment to connect with family. The user may be ill and a negative sentiment may be indicated through frequent searches for symptoms of an illness or negatively worded posts on social media. The program may detect this user-derived data as a negative sentiment. The program may determine a sentiment modification action that may introduce a more positive sentiment to the user. The desired positive sentiment may include actions, behaviors, and attitudes related to or indicating health, happiness, and family. The program may provide the elderly patient with a set of selected social networking data meant to introduce positive sentiment. The positive sentiment may be introduced through the promotion or enlargement of pictures of and messages from the patient's grandchildren. The positive sentiment may also be introduced through the initiation of an interaction with a social networking user who is a nurse or caregiver in the nursing home. The promoted selected social networking data may include cheerful blog posts created by the nurse or an article written by the caregiver with advice on recovery. The program may monitor and change the sentiment modification action. For example, the recovery advice may remind the patient he or she is ill, and may not improve their mood. The program may decide to filter-out, remove, or reduce the number of posts pertaining to illness. The program may promote or amplify messages from the patient's family if it seems to be increasing the amount of positive sentiment of the patient.

Method 200 concludes at block 299. As described herein, aspects of method 200 related to using social networking data (e.g., messages, still images, videos) to dynamically (e.g., in real-time, ongoing, on-the-fly) assess the sentiment of a user and provide a more positive sentiment to the user through the social networking environment. Aspects of method 300 may provide performance or efficiency benefits for improving sentiment of social networking users. Aspects may save resources such as bandwidth, disk, processing, or memory. Aspects may save bandwidth through the promotion and placement of desired content for the user. Social networking content that may be important to the specific user or group of users may be placed at or promoted to the top of the viewstream of the specific user. The placement and promotion of important social networking content may save the time and bandwidth of the specific user. Aspects may save disk through the filtering-out and removal of negative sentiment content. Negative sentiment content in the social networking environment of the specific user may be occupying valuable disk space on the user's computer, cell phone, or other social networking device. The filtering-out or removal of negative sentiment content may save the disk space of the user. This may also save the processing time of the user. If there is a larger amount of free disk space on the device of the specific user, the device may be able to run faster. Aspects may save memory in a similar way as well. Memory may be saved through the filtering-out and removal of negative sentiment content. Altogether, leveraging sentiment-driven content assessment for a communication may be associated with content relevance, ease of understanding, and communication reliability.

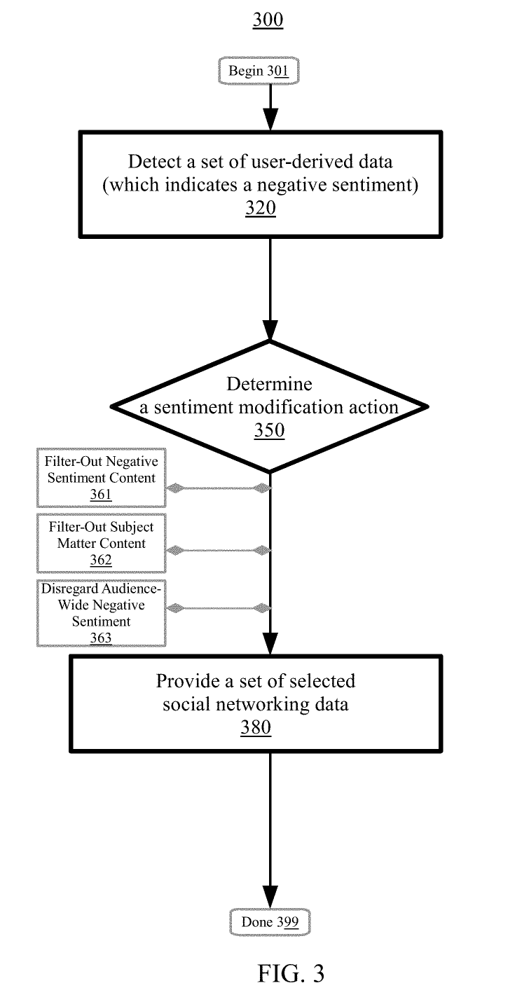

FIG. 3 is a flowchart illustrating a method 300 for sentiment-driven content management in a social networking environment, according to embodiments. Aspects of method 300 may be similar or the same as aspects of method 200, and aspects may be utilized interchangeably with one or more methodologies described herein. The method 300 may begin at block 301.

At block 320, a set of user-derived data may be detected in the social networking environment. The set of user-derived data may indicate a negative sentiment of a user that corresponds with the set of user-derived data. At block 350, a sentiment modification action may be determined for the social networking environment. The determination of the sentiment modification action may be based on the set of user-derived data which indicates the negative sentiment of the user.

In embodiments, a set of negative sentiment contents may be filtered-out at block 361. The filtering-out may include removing, reducing, or otherwise eliminating the set of negative sentiment contents. Filtering-out a set of negative sentiment contents may include filtering-in a set of positive sentiment contents. The filtering-out may include reducing the size of negative images, decreasing the number of negative posts, altogether removing negative sentiment contents, or other actions. Filtering-in may include adding, increasing, or otherwise accumulating the set of positive sentiment contents. The negative sentiment content may include any type of social networking data that may introduce, invoke, or provide the user or group of users with a negative sentiment. The filtering-out of the set of negative sentiment contents may occur with respect to the set of selected social networking data. The filtering-out of the set of negative sentiment contents may occur pertaining to, from, or within the set of selected social networking data. The filtering-out of the set of negative sentiment contents may occur to carry-out the sentiment modification action.

Consider the following example. A specific user may have recently been diagnosed with gluten intolerance. The specific user may be having a difficult time adjusting to the intolerance. The social networking environment of the user may include pictures of and recipes for meals that the user can no longer eat. The negative sentiment of the user may be detected after viewing pictures of and recipes for pizza. The sentiment modification action may include the filtering-out of social networking data related to pizza. The sentiment modification action may also include the filtering-in of gluten-free pasta recipes or other gluten-free meal ideas that tend to not induce a negative sentiment. The sentiment modification action can filter the selected social networking data to improve the sentiment of the user. Other methods of filtering-out and filtering-in a set of sentiment contents may also be possible.

In embodiments, a set of subject matter contents which correlate to the set of user-derived data may be filtered-out at block 362. The set of subject matter may compare to, relate to, associate with, or otherwise connect to the set of user-derived data. The set of subject matter contents may be topics, subjects, or other content specific to the user. The set of subject matter content may correlate to the set of user-derived data through keywords, trending topics, frequent searches, matching within a threshold, or other methods. The set of subject matter content may be a specific topic that correlates to a negative sentiment of the user. The filtering-out of the set of subject matter contents may occur with respect to the set of selected social networking data. The filtering-out of the set of subject matter contents may occur to carry-out the sentiment modification action.

Consider the following example. A terminally ill patient may be a user of a social networking environment. The program may detect a negative sentiment of this patient in connection with social networking data related to not only their specific illness, but all terminal illnesses. The program detects this through negative keywords in posts by the user about terminal illness and trends in negative sentiment of the user after viewing posts related to terminal illness. The sentiment modification action for this patient may include the filtering-out of posts related to their specific illness. The sentiment modification action for this patient may also include the filtering-out of posts related to all terminal illnesses. The set of subject matter contents which correlate to the set of user-derived data may be all terminal illnesses, not just the specific illness affecting the patient. The filtering-out of the set of subject matter contents related to all terminal illnesses may introduce a more positive sentiment to the patient. Other methods of filtering-out a set of subject matter contents which correlates to a set of user-derived data may also be possible.

In embodiments, an audience-wide negative sentiment of the social networking environment may be disregarded at block 363. The audience-wide negative sentiment may include a negative sentiment that a larger group, population, or other type of audience may react negatively to. This group may include all the users of a particular social networking platform, application, or website. This group may also include a particular demographic or category of users of a particular social networking environment. The negative sentiment may be less user-specific and more external. The audience-wide negative sentiment may be disregarded, ignored, or otherwise discounted. The disregarding of the audience-wide negative sentiment may occur to carry-out the sentiment modification action.

Consider the following example. The audience may include a town-wide community suffering from the loss of a high school student in a car accident. The program may detect a negative sentiment in many social networking users in this town after reading online news articles about the death of the student and seeing pictures and messages posted by friends of the student. This negative sentiment may be more external town-wide instead of user-specific. The sentiment modification action may include filtering-out, reducing, or removing social networking data related to the death of the student. Social networking data about the death of the student will be made less prominent in the social networking environment of the community. The negative sentiment may be disregarded. Other methods of disregarding an audience-wide negative sentiment of the social networking environment may also be possible.

At block 380, a set of selected social networking data may be provided to the user. The providing of the set of selected social networking data may be based on the sentiment modification action. The set of selected social networking data may be provided in the social networking environment. Method 300 concludes at block 399. Aspects of method 300 may have various performance or efficiency benefits as described herein.

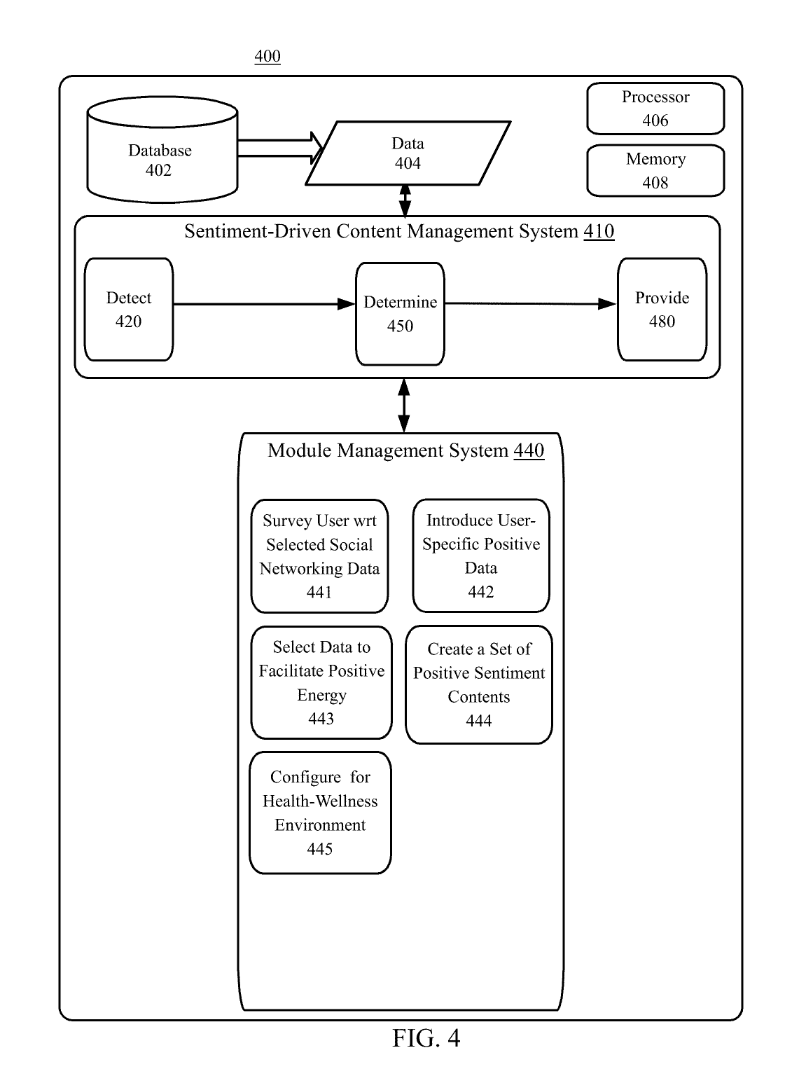

FIG. 4 shows an example system 400 for sentiment-driven content management in a social networking environment, according to embodiments. The example system 400 may include a processor 406 and a memory 408 to facilitate implementation of sentiment management. The example system 400 may include a database 402 configured to maintain data used for sentiment-driven content management. In embodiments, the example system 400 may include a sentiment-driven content management system 410. The sentiment-driven content management system 410 may be communicatively connected to the database 402, and be configured to receive data 404 (e.g., electronic message, sentiment data, biometry data) related to sentiment management. The biometric-based sentiment management system 410 may include a detecting module 420 to detect a set of user-derived data in the social networking environment, a determining module 450 to determine a sentiment modification action for the social networking environment, and a providing module 480 to provide a set of selected social networking data to the user. The sentiment-driven content management system 410 may be communicatively connected with a module management system 440 that includes a set of modules for implementing aspects of sentiment management.

In embodiments, the user may be surveyed with respect to the set of selected social networking data at module 441. The user may be surveyed, questioned, polled, sampled, or otherwise asked to provide the selected social networking data with feedback. The user may be asked to confirm, deny, or otherwise establish their sentiment with respect to the set of selected social networking data (e.g., commenting on a post, taking a survey). The selected social networking data may ask for or require feedback or recommendations from the user or group of users for each content item. The surveying of the user may be implicit (e.g., questioning the user about how their day went) or explicit (e.g., specifically asking the user how a specific post made them feel). The surveying of the user may occur to carry-out the sentiment modification action. The surveying may identify an immediate, short-term, or long-term feeling, emotion, or opinion from the user. The surveying of the user may help the social networking environment better determine the sentiment modification action.

Consider the following example. A specific user may have recently been diagnosed with depression or another mental health disorder. The sentiment modification action for this specific user may include the promotion of physical fitness articles to promote a better sentiment. The user may view these physical fitness articles. For instance, the user may be surveyed about these articles implicitly (e.g., surveyed at the end of the week about how they felt the previous week) or explicitly (e.g., polled to determine whether learning about and becoming involved in physical fitness introduced a more positive sentiment). Other methods of surveying the user with respect to the selected social networking data are also possible.

In embodiments, a user-specific batch of positive sentiment data may be introduced to the set of selected social networking data at module 442. The user-specific batch of positive sentiment data may be a group of data including messages, still images, videos, and other media. The user-specific batch of positive sentiment data may be specific to, personalized for, or otherwise connected to the specific interests, hobbies, and other information regarding the specific user. The user-specific batch of positive sentiment data may be historical or prior data that may have been shown/indicated to introduce positive sentiment to the specific user. The introduction of the user-specific batch of positive sentiment data may occur to carry-out the sentiment modification action.

Consider the following example. A specific user may be a fan of a specific sports team. A user-specific batch of positive sentiment data for this specific user may be videos of the specific team's best wins or plays, interviews with players on the specific team, or blogs or social networking accounts run by players on the specific team. The user-specific batch of positive sentiment data may be determined by frequent online searches for the team or particular players. The program may detect a negative sentiment from this specific user. The specific user may also be angry or upset after an argument with a coworker. The sentiment modification action may include introducing a user-specific batch of positive sentiment data. The user-specific batch of positive sentiment data (e.g., the blog of the star player, an article about the team's most recent win) may be promoted to the top of the user's social networking feed or viewstream. The user-specific batch of positive sentiment data may introduce a more positive sentiment to the user. Other methods of introducing a user-specific batch of positive sentiment data are also possible.

In embodiments, the set of selected social networking data may be selected to facilitate a positive energy factor of the user at module 443. The positive energy factor may be selected, introduced, or otherwise chosen to facilitate a positive energy factor of the user. The positive energy factor may be selected to facilitate, create, or otherwise enable a positive energy factor of the user. The positive energy factor may include a qualitative or quantitative measure of an individual attribute such as vocal tone, facial expression, body language, word usage, appetite, or other senses. The positive energy factor may utilize a biometric sensor or other sensor of health and wellness (e.g., a heart rate consistent with mood or energy, a desire to engage in normal routine activities) to gather data about the sentiment of the user. The positive energy factor may also utilize a baseline sensor (e.g., a normal level of social networking responses in comparison to historical data). The selection of the set of social networking data may be based on the set of user-derived data. The set of user-derived data may indicate a negative energy factor of the user.

Consider the following example. A specific user may be a patient in a nursing home who has no interest in participating in events that the other patients attend. The specific user may indicate this sentiment in their social networking environment. The positive energy factor may be introduced to the specific user. Cheerful messages from the user's grandchildren may be promoted in the user's social networking environment. The patient may receive this positive sentiment in their social networking environment. The messages may facilitate a more positive energy factor. The patient may gain interest in participating in events at the nursing home. Other examples of the facilitation of a positive energy factor are also possible.

In embodiments, a set of positive sentiment contents may be created to offset the set of user-derived data which indicates the negative sentiment of the user at module 444. The set of positive sentiment contents may be created, generated, or otherwise produced to offset the set of user-derived data which indicates the negative sentiment of the user. The set of positive sentiment contents may be created in the form of still images, videos or other media by the social networking environment. The set of positive sentiment contents may be directly or indirectly related to the set of user-derived data and negative sentiment. The set of positive sentiment contents may be created to offset, counter, counteract, or eliminate the negative sentiment of the user. The creation of the set of positive sentiment contents may be utilized in the set of selected social networking data.

Consider the following example. A specific user may have recently lost their job. The user may indicate a negative sentiment in their social networking environment through angry emojis or updates including keywords that indicate depression. The sentiment modification action may include the creation, generation, or production of positive sentiment contents. The positive sentiment contents may be messages including happy emojis or updates including keywords that indicate a calmer mood. The set of positive sentiment contents may create a more positive sentiment for the user. Other examples of creating a set of positive sentiment contents are also possible.

In embodiments, the social networking environment may be configured for a health-wellness environment at module 445. The social networking environment may be configured, organized, arranged, or otherwise constructed for a health-wellness environment. The health-wellness environment may be a hospital, nursing home, rehabilitation center, school, or other health-wellness environment at which the specific user frequents, is located, or otherwise interacts with. The health-wellness environment may include a set of information security configurations (e.g., passwords in order to access birthdates, staff credential token in order to enter new medical information). The health-wellness environment may include a set of user health-wellness records (e.g., immunization history, illness history). The health-wellness environment may include a set of health-wellness professional facilitator-users (e.g., medical professional user). The set of health-wellness professional facilitator-users may develop at least a portion of the selected social networking data. The health-wellness environment may include sensitive personal data. The sensitive personal data may not be a public matter for a social networking environment. The social networking environment may need to be more secure than the typical social networking environment.

Consider the following example. A specific user of the online social network may be a patient suffering from skin cancer. The specific user may be undergoing therapy for their skin cancer and may be a patient at a hospital. The specific user may use their social networking environment to discuss their current condition. The detected user-derived data may include the current condition of the user, in this case skin cancer. The determined sentiment modification action may include providing the user with positive energy updates. The user-derived data of the specific user may include personal medical records, in this case skin cancer. The user-derived data of the specific user may include a set of health-wellness professional facilitator-users. In this case, the set of health-wellness professional facilitator-users may include the doctors and/or nurses of the skin cancer patient. The doctors and nurses of the user may also add personal information to the social networking data. The social networking environment may be secured using required passwords. The user may need to enter a password to access their medical records regarding the skin cancer, personal information, or personal information regarding their doctors and nurses. Other methods of configuring the social networking environment for a health-wellness environment are also possible. Method 400 concludes at block 499. Aspects of method 400 may have various performance or efficiency benefits as described herein.

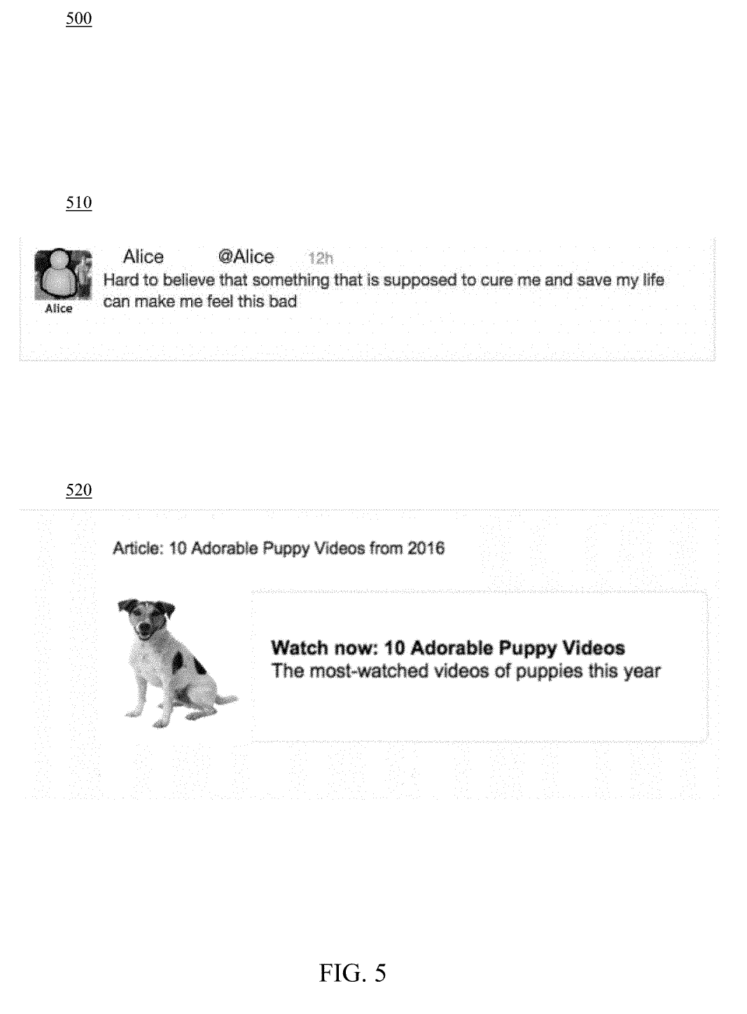

FIG. 5 illustrates an example social networking interface 500 for sentiment-driven content management, according to embodiments. Consider the following example. A specific user may be a cancer patient. The specific user may indicate on their social networking environment that the treatments for their cancer do not seem to be helping. Sadness and illness, the negative sentiments of the user, may be detected through keywords in posts such as “cancer” or “miserable”, or through the use of frowning emojis. A sentiment modification action may be determined based on the detected negative sentiment. The sentiment modification may include providing the user with videos of puppies and other positive social networking data. The sentiment modification action may also initiate contact of the patient with a facilitator-user, such as an experienced cancer doctor. The cancer doctor may be able to introduce positive sentiment to the social networking environment of the patient through frequently posting articles involving the advancement of cancer treatment. The articles involving the advancement of treatment may be promoted to the top of the user's social networking feed or viewstream. The puppy videos may appear larger in comparison to other posts or may flash to catch the user's attention. The patient may start to use smiling emojis and positive keywords such as “happy” or “funny”, indicating that the patient may have a more positive sentiment after viewing this data.

The cancer patient may still have a negative sentiment after viewing this data, which is apparent through the continued use of negative keywords and emojis. The sentiment modification action may change based on the sentiment of the user. The sentiment modification action may amplify the number of videos and inspiring articles that the patient views (e.g., six videos of puppies instead of two). The sentiment modification action may change so that instead of promoting these positive posts, posts that may introduce a negative sentiment to the patient are filtered-out. For example, if a fellow cancer patient in the social networking environment of the specific user often posts negative messages about their own treatment, the sentiment modification action may remove or reduce this fellow patient from the user's viewstream (e.g., one post from this fellow patient instead of three). The sentiment modification action may filter-out all posts pertaining to any type of illness or disregard posts pertaining to stressful news headlines, such as destructive hurricanes and major crime. The news headlines may be filtered out if they are detected to introduce a negative sentiment in an entire audience or community. The patient may be introduced to a set of user-specific positive data (e.g., encouraging messages from their close friends, videos of their favorite breed of dog). The patient may be surveyed to see if the promotion of the messages or viewing of the videos introduced a more positive sentiment. For example, after viewing a specific puppy video, the patient may be asked about how their day is going or what they thought about the video. The patient may also spend a lot of time in a hospital or care facility. The social networking environment of the user may be configured for this health-wellness environment. Security configurations may be created to protect the personal medical information of the patient (e.g., chemotherapy treatment history, dates of appointments). Other methods of sentiment-driven content management are also possible.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

What is claimed is:

1. A computer-implemented method for sentiment-driven content management in a social networking environment, the method comprising:
detecting, in the social networking environment, a set of user-derived data which indicates a negative sentiment of a user that corresponds with the set of user-derived data;
determining, based on the set of user-derived data which indicates the negative sentiment of the user, a sentiment modification action for the social networking environment; and
providing, in the social networking environment based on the sentiment modification action, a set of selected social networking data to the user.

2. The method of claim 1, further comprising:
introducing, to carry-out the sentiment modification action, a positive sentiment to the user in the set of selected social networking data.

3. The method of claim 2, further comprising:
monitoring, in response to providing the set of selected social networking data to the user, a sentiment trend of the user; and
changing, based on the sentiment trend of the user, the sentiment modification action.

4. The method of claim 3, further comprising:
altering, based on the sentiment trend of the user, a set of scaling factors of the sentiment modification action.

5. The method of claim 3, further comprising:
altering, based on the sentiment trend of the user, a set of typologies of the sentiment modification action.

6. The method of claim 2, further comprising:
initiating, to carry-out the sentiment modification action, an interaction from a facilitator-user to the user in the set of selected social networking data; and
introducing, in the set of selected social networking data, the positive sentiment from the facilitator-user.

7. The method of claim 1, further comprising:
promoting, in a viewstream to carry-out the sentiment modification action, the set of selected social networking data with respect to other social networking data.

8. The method of claim 1, further comprising:
filtering-out, with respect to the set of selected social networking data to carry-out the sentiment modification action, a set of negative sentiment contents.

9. The method of claim 1, further comprising:
introducing, to carry-out the sentiment modification action, a user-specific batch of positive sentiment data to the set of selected social networking data.

10. The method of claim 1, further comprising:
filtering-out, with respect to the set of selected social networking data to carry-out the sentiment modification action, a set of subject matter contents which correlates to set of user-derived data.

11. The method of claim 1, further comprising:
disregarding, to carry-out the sentiment modification action, an audience-wide negative sentiment of the social networking environment.

12. The method of claim 1, further comprising:
surveying, to carry-out the sentiment modification action, the user with respect to the set of selected social networking data.

13. The method of claim 1, further comprising:
selecting, based on the set of user-derived data which indicates a negative energy factor of the user, the set of selected social networking data to facilitate a positive energy factor of the user.

14. The method of claim 1, further comprising:
creating, for utilization in the set of selected social networking data, a set of positive sentiment contents to offset the set of user-derived data which indicates the negative sentiment of the user.

15. The method of claim 1, further comprising:
configuring the social networking environment for a health-wellness environment having:
a set of information security configurations,
a set of user health-wellness records, and
a set of health-wellness professional facilitator-users to develop at least a portion of the set of selected social networking data.

16. The method of claim 1, wherein the detecting, the determining, and the providing each occur in a dynamic fashion to streamline sentiment-driven content management.

17. The method of claim 1, wherein the detecting, the determining, and the providing each occur in an automated fashion without user intervention.

18. A system for sentiment-driven management in a social networking environment, the system comprising:
a memory having a set of computer readable computer instructions, and
a processor for executing the set of computer readable instructions, the set of computer readable instructions including:
detecting, in the social networking environment, a set of user-derived data which indicates a negative sentiment of a user that corresponds with the set of user-derived data;
determining, based on the set of user-derived data which indicates the negative sentiment of the user, a sentiment modification action for the social networking environment; and
providing, in the social networking environment based on the sentiment modification action, a set of selected social networking data to the user.

19. A computer program product for sentiment-driven content management in a social networking environment, the computer program product comprising a computer readable storage medium having program instructions embodied therewith, wherein the computer readable storage medium is not a transitory signal per se, the program instructions executable by a processor to cause the processor to perform a method comprising:
detecting, in the social networking environment, a set of user-derived data which indicates a negative sentiment of a user that corresponds with the set of user-derived data;
determining, based on the set of user-derived data which indicates the negative sentiment of the user, a sentiment modification action for the social networking environment; and
providing, in the social networking environment based on the sentiment modification action, a set of selected social networking data to the user.

20. The computer program product of claim 19, wherein at least one of:
the program instructions are stored in the computer readable storage medium in a data processing system, and wherein the program instructions were downloaded over a network from a remote data processing system; or
the program instructions are stored in the computer readable storage medium in a server data processing system, and wherein the program instructions are downloaded over a network to the remote data processing system for use in a second computer readable storage medium with the remote data processing system.
